(19) United States
(12) Patent Application Publication
(10) Pub. No.: US 2005/0279858 A1
(43) Pub. Date: Dec. 22, 2005

(54) Sprinkler head guard

(76) Inventor: George Lanni, Ossining, NY (US)

Correspondence Address: MCANDREWS HELD & MALLOY, LTD, 500 WEST MADISON STREET, SUITE 3400, CHICAGO, IL, 60661, US

(21) Appl. No.: 10/858,316

(22) Filed: Jun. 1, 2004

(51) Int. Cl. B05B 15/06

(52) U.S. Cl. 239/288; 239/201; 239/203; 239/276

(57) ABSTRACT

A sprinkler head guard includes a body with a passage. The body has a depth permitting the guard to be removably embedded adjacent to a sprinkler head commonly used with an in-ground sprinkler irrigation system. The passage of the body is adapted to permit a sprinkler head commonly used with an in-ground sprinkler irrigation system to pass through the body skyward from the in-ground sprinkler irrigation hoses.

### CROSS-REFERENCE TO RELATED APPLICATION

None

### STATEMENT REGARDING FEDERALLY-SPONSORED RESEARCH OR DEVELOPMENT

None

### BACKGROUND OF THE INVENTION

The present invention relates to in-ground sprinkler irrigation systems, and more particularly, to rigid guards for sprinkler heads used in connection with such in-ground sprinkler irrigation systems. The present invention relates to a rigid guard with a passageway adapted to receive a sprinkler head such that the sprinkler head may be positioned and protected within the passage.

In-ground sprinkler systems are common in both commercial and residential settings. Such in-ground sprinkler irrigation systems are used to automatically irrigate lawns and gardens eliminating the need for a groundskeeper to manually irrigate. A typical in-ground system will have underground hoses or tubing for delivering water to sprinkler heads that typically extend skyward from the hose and are exposed above ground. In such a system, typically water is delivered to the sprinkler heads through the underground hoses. The water pressure of the delivered water may activate the sprinkler head such that a central portion of the sprinkler head pops up from a base portion of the sprinkler head and sprays the water onto the lawn or garden adjacent the sprinkler head.

During normal maintenance of the lawn or garden area, groundskeepers typically use heavy-duty machinery and tools for moving the earth and plants. Such machinery and tools may occasionally impact the sprinkler heads causing damage. If the damage is substantial, the sprinkler head must be replaced immediately to ensure that the adjacent lawn or garden area is not deprived of its regular watering. If the damage is minor, the sprinkler head may not need to be replaced immediately but after a number of such impacts, the sprinkler head will be sufficiently damaged that it, too, will be unable to operate requiring immediate replacement.

Various sprinkler head guards have been used in the past. For example, a donut-shaped guard has been used in connection with such in-ground sprinkler system heads. Such donut-shaped guards, however, have not provided sufficient protection in that they are easily displaced from around the sprinkler head and also the earth adjacent to such donut-shaped guards is easily eroded, often dislodging the donut-shaped guard from its intended location. Such displacement can itself cause damage to the sprinkler head or create a hazard for passersby who may stumble on the dislocated donut-shaped guard.

Accordingly, it is an object of the present invention to provide a guard for a sprinkler head associated with an in-ground sprinkler irrigation system. It is a further object of the present invention to provide a stable guard that is removably embeddable in the ground adjacent to a sprinkler head of an in-ground sprinkler irrigation system.

### SUMMARY OF THE INVENTION

The present invention is directed to a guard for a sprinkler head of an in-ground sprinkler irrigation system. The guard comprises a triangle, square, rectangle, trapezoid, or other-shaped body of a depth sufficient to be embedded into the ground. The body also includes a passage through which the sprinkler head of the in-ground sprinkler irrigation system may pass. The guard may be embedded into the ground adjacent the sprinkler head such that the sprinkler head passes through the passageway of the body and the upper surface of the body is made to lie generally in the same plane as the adjacent ground.

### BRIEF DESCRIPTION OF THE DRAWINGS

FIG. 1 is a perspective elevated view of one embodiment of the guard of the present invention.

FIG. 2 is a perspective elevated view of one embodiment of the guard of the present invention.

FIG. 3 is a perspective elevated view of one embodiment of the guard of the present invention.

### DETAILED DESCRIPTION OF THE PREFERRED EMBODIMENT

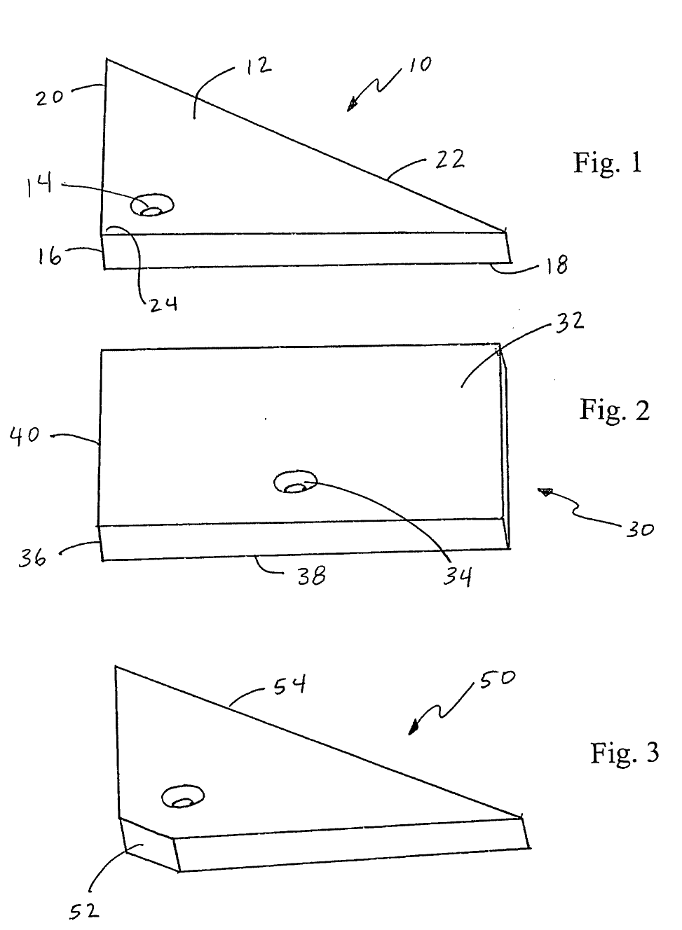

FIG. 1 is a perspective elevated view of one embodiment of the guard 10 of the present invention. The guard 10 of the present invention comprises a base 12 having a passage 14. The passage 14 is adapted to permit a sprinkler head (not shown) of an in-ground sprinkler irrigation system to pass from the ground beneath the guard 10 through passage 14. Typically, a sprinkler head is activated when water is fed through the in-ground sprinkler irrigation system. A central portion of the sprinkler head pops up above a base portion permitting the sprinkler head to spray water onto the adjacent lawn or garden areas. The passage 14 provides adequate clearance for the base portion of such common sprinkler heads and when the sprinkler head is activated, the central portion may pop up to spray the adjacent lawn or garden areas. The guard 10 preferably has a depth 16 sufficient for the guard 10 to be adequately and removably embedded into the ground adjacent the sprinkler head. That is, the guard 10 may be imbedded into the ground such that it is firmly held in its intended position by the adjacent earth but may be removed from the ground because it is not installed permanently such as a concrete sidewalk. The purpose of the guard 10 is to provide a stable and firm guard for a sprinkler head that may be retrofitted onto presently existing in-ground sprinkler irrigation systems as well as fitted on original installations. Additionally, the depth 16 cannot be such that the guard 10 will interfere with the installed in-ground sprinkler irrigation system. Preferably the block has a depth 16 of three inches.

The guard 10 of FIG. 1 has a triangular shape. This triangular shape is particularly useful in areas where a sprinkler head is installed in a corner of a lawn or garden adjacent to two intersecting concrete or other such walkways or paths. Block 10 is shown having one corner 24 defined by a right angle. Such a configuration would be useful when the walkways or paths intersect perpendicular to each other. The guard 10 may be installed with its right angle corner at the intersection of the two paths. In such an installation, length 18 will sit immediately adjacent one sidewalk or path and length 20 will sit immediately adjacent the second walkway or path.

Passage 14 may be located anywhere within body 12 to accommodate the specific location of the sprinkler head relative to the adjacent walkways or paths. Alternatively, guard 10 may be moved slightly away from the walkways or paths such that opening 14 aligns with the sprinkler head to permit the sprinkler head passage through opening 14.

There is no particularly preferred size corresponding to length 18, length 20, or length 22. It has been found, however, that a length of twelve inches for length 18 and length 20 has been useful. Of course, the useful sizes for length 18, length 20, and length 22 will depend on the particular application regarding a lawn or garden into which the guard 10 will be installed.

Although block 10 of FIG. 1 is shown with a right angle corner 24, those skilled in the art will understand that a block 12 having different angles may be preferred to accommodate garden configurations where walkways and paths do not intersect perpendicular to each other.

The guard 10 may be made of any rigid material capable of withstanding the outdoor elements. Preferably, however, the block will be made of concrete or other such rock-like material because the tools and other implements often used in lawn and garden care can easily damage other materials often used in lawn and garden applications, such as plastics. In particular, edging devices that use a nylon cord have been found to be especially destructive to sprinkler heads and other plastic garden implements. A particularly preferred construction for the guard 10 is a concrete block strengthened with rebar rod or wire mesh.

FIG. 2 is a perspective elevated view of an embodiment of the guard 30 of the present invention. The guard 30 consists of a block 32 having a passage 34. As with the passage 14 of FIG. 1, the passage 34 is adapted to permit a sprinkler head from an in-ground sprinkler irrigation system to pass through the block 32 such that when activated a central portion of the sprinkler head may pop up from the base portion above the block 32 to permit watering of the adjacent lawn or garden area. The depth 36 of guard 30 should again be sufficient to permit the block 32 to be immovably embedded in the ground adjacent the sprinkler head but not so great to interfere with the in-ground sprinkler system. As noted above, a preferred depth is three inches.

Guard 30 is illustrated in FIG. 2 as having a rectangular shape with lengths 38 and 40. Of course, those skilled in the art will understand that the length 38 and length 40 may be individually adapted to the particular application or lawn or garden use. Further, those skilled in the art will understand that there is no specific preferred shape for the guard 30. The only requirements for the guard 30 are that it have a sufficient depth 36 to permit the guard 30 to be immovably embedded into the ground adjacent the sprinkler head and that the passage 34 be positioned within block 32 at a location to both accommodate the sprinkler head placement within the garden and the in-ground sprinkler irrigation system and sufficiently distant from the length 38 and length 40 (preferably at least about 1.5 inches) to provide the desired protection to the sprinkler head. Accordingly, it should be understood that any regular or irregular shape may be used depending only on the user's particular applications and likes.

Block 30 having a rectangular shape is particularly useful for those sprinkler head placements immediately adjacent a straight length of walkway or sidewalk. The length 38, or alternatively, the length 40 may be placed immediately adjacent the walkway.

FIG. 3 is a perspective elevated view of an embodiment of the guard 50 of the present invention. FIG. 3 shows a guard 50 similar to the guard 10 of FIG. 1 except that the right angle corner 24 shown in FIG. 1 has been cut short to provide a truncated side 52 running generally parallel to the opposite side 54. This type of configuration has also been found to be particularly useful and aesthetically pleasing for protecting sprinkler heads adjacent to a straight length of a walkway or path. This is an alternative embodiment for such locations to the guard 30 of FIG. 2. Either the truncated side 52 or the opposite side may preferably be placed immediately adjacent to the straight length of walkway or path. In all other respects, the description of the guard 10 of FIG. 1 applies equally to the guard 50 of FIG. 3.

While particular embodiments of the invention have been shown, it will be understood that the invention is not limited thereto since modifications may be made by those skilled in the art, particularly in light of the foregoing teaching. It is therefore, the appended claims that define the true spirit and scope of the invention

1. A sprinkler head guard comprising:
a body configured to be removably imbedded into the ground adjacent a sprinkler head used in connection with an in-ground sprinkler irrigation system;
the body having a passage adapted to accommodate a sprinkler head;
the body having a depth sufficient to permit the guard to be removably imbedded into the ground while not interfering with the in-ground sprinkler irrigation system.

2. The sprinkler head guard of claim 1 wherein the body has a generally triangular shape adapted to be installed at the intersection of two walkways or paths.

3. The sprinkler head guard of claim 1 wherein the depth of the body is about 3 inches.

4. The sprinkler head guard of claim 1 wherein the body further comprises an edge defining its outer periphery and the passage is positioned at least about 1.5 inches away from the edge of the body.
